(19) United States
(12) Patent Application Publication
(10) Pub. No.: US 2005/0259847 A1
(43) Pub. Date: Nov. 24, 2005

(54) System and method for tracking parcels on a planar surface

(76) Inventors: Yakup Genc, Princeton, NJ (US); Yanghai Tsin, Plainsboro, NJ (US); Cuneyt Akinlar, Eskisehir (TR); Anurag Mittal, Plainsboro, NJ (US); Xiang Gao, Landsdale, PA (US)

Correspondence Address: Siemens Corporation;Intellectual Property Department, 170 Wood Avenue South, Iselin, NJ, 08830, US

(21) Appl. No.: 11/046,717

(22) Filed: Jan. 31, 2005

Related U.S. Application Data
(60) Provisional application No. 60/540,130, filed on Jan. 29, 2004.
(60) Provisional application No. 60/540,081, filed on Jan. 29, 2004.
(60) Provisional application No. 60/540,150, filed on Jan. 29, 2004.

(51) Int. Cl. G06K 9/00

(52) U.S. Cl. 382/103; 382/151

(57) ABSTRACT

A system and method for tracking parcels on a planar surface is provided. The method comprising: acquiring an image of the parcel located on the planar surface; determining edges of the parcel; projecting the edges onto the planar surface; determining which edges belong to each side of the parcel; calculating a cost function associated with the edges belonging to each side of the parcel; searching the edges belonging to each side of the parcel to find edges having a lowest cost; and constructing a matching configuration of the parcel using the edges having the lowest cost.

### CROSS-REFERENCE TO RELATED APPLICATIONS

This application claims the benefit of U.S. Provisional Application Nos. 60/540,130, 60/540,081 and 60/540,150, all filed Jan. 29, 2004, copies of which are herein incorporated by reference.

### BACKGROUND OF THE INVENTION

1. Technical Field

The present invention relates to real-time tracking of parcels, and more particularly, to a system and method for tracking parcels undergoing free-form motion on a conveyor belt.

2. Discussion of the Related Art

In the past, parcels were transported by a conveyor belt to an automatic sorter. Each parcel, which was typically labeled with a bar code for identification, would occasionally have to be oriented by an attendant so that the label could be detected and read by the sorter. In such systems, the parcels were often delivered to the sorter in bunches, making them difficult to handle and sometimes creating jams. Thus, an attendant would be required to perform a process known as singulation, which is the separation of the parcels from each other, to enable the automatic sorter to operate correctly. Due to the non-uniform shape and size of the parcels, this effort was time-consuming and cumbersome to the attendant.

Recent automated parcel delivery systems now include automatic parcel singulation systems. These systems are used to separate parcels from each other to prepare them for automated distribution. However, when the parcels are stacked or lay too close to each other, an automated system cannot always singulate the parcels for proper sorting because a group of parcels may be seen as one parcel by the system.

In order to reliably singulate parcels for proper sorting, machines that include, for example, a singulator, a side-by-side remover, a flow controller, and a recirculating conveyer have been developed. In such machines, parcels enter the singulator through an infeed and are driven to one side by skewed rollers. Successive belts may be included in these machines to increase the speed of the parcels or to create spaces between the parcels. The skewed rollers align the parcels to one side of the machine to form a straight line and the side-by-side remover transports downstream any packages of the width of the narrowest parcel while deviating other packages to be recirculated back onto the singulator.

In some singulation systems, the side-by-side remover is augmented with an optical recognition system that detects parcels. In addition, these automated systems sometimes use dimensioning equipment to measure the external characteristics of the parcels as they move along the conveyor belt. Although, these systems may include an optical recognition system for detecting parcels, they typically do not include a device for detecting and tracking parcels as they move along the conveyor belt.

Accordingly, there is a need for a technique of accurately detecting and tracking parcels in real-time as they move along a conveyor belt in a quick and cost-effective manner.

### SUMMARY OF THE INVENTION

The present invention overcomes the foregoing and other problems encountered in the known teachings by providing a system and method for tracking parcels on a planar surface.

In one embodiment of the present invention, a method for tracking a parcel on a planar surface comprises: acquiring an image of the parcel located on the planar surface; determining edges of the parcel; projecting the edges onto the planar surface; determining which edges belong to each side of the parcel; calculating a cost function associated with the edges belonging to each side of the parcel; searching the edges belonging to each side of the parcel to find edges having a lowest cost; and constructing a matching configuration of the parcel using the edges having the lowest cost.

The edges are determined by using one of a Canny edge detection technique and a background image boundary. The edges are determined after fitting straight edges to edge pixels of the image, wherein the step of fitting straight edges comprises: obtaining a set of connected edges from the image; fitting lines to edge pixels of the image; recording directions of the lines in an accumulator; determining straight lines that can be fit to the set of connected edges; and fitting the straight lines to the edge pixels of the image.

The accumulator is a Hough accumulator. The edges are projected onto the planar surface from one of a top and bottom surface of the parcel. The step of determining which edges belong to each side of the parcel comprises: screening the projected edges with a set of parameters for determining which of the projected edges belong to each side of the parcel, wherein the set of parameters includes a distance of each edge from its projected location, a length of each edge, and an angular orientation of each edge.

The step of determining which edges belong to each side of the parcel comprises: determining corresponding edge pixels between the projected top surface edges and the top surface edges of the image using a correspondence based registration method. The correspondence based registration method is one of an iterative closest points (ICP) method and a Hough transform voting method.

The step of determining which edges belong to each side of the parcel comprises: analyzing an intensity difference signature of the projected top surface edges; and adjusting an intensity threshold and resolution of the projected top surface edges. The cost function is a weighted sum of a plurality of factors, the factors including: a deviation from a perpendicularity between adjacent edges, a deviation from parcel dimensions for opposite edges, a deviation from the parcel dimensions for each edge, and a distance of the parcel from a predicted location. The lowest cost function is determined by finding a combination of the plurality of factors that has a lowest cost. The matching configuration of the parcel includes an edge match for each side of the parcel.

In another exemplary embodiment of the present invention, a method for tracking a parcel on a planar surface comprises: acquiring a first image of the parcel located on the planar surface; computing a three-dimensional (3D) position and orientation of the parcel according to its relative motion space; projecting top surface edges of the parcel associated with the computed 3D position and orientation onto the planar surface; determining an amount of overlay between the projected top surface edges and the top surface edges of the first image; and generating a matching score using the amount of overlay between the projected top surface edges and the top surface edges of the first image.

The relative motion space of the parcel is defined by a vector (ΔX, ΔY, Δθ), which corresponds to position changes of the parcel in the X and Y directions and a rotational angle. The projection of the top surface edges onto the planar surface is computed using a Tsai model.

The step of determining an amount of overlay between the projected top surface edges and the top surface edges of the first image, comprises: traversing a contour of the projected top surface edges to determine a position of edge pixels on the projected top surface edges; detecting the edge pixels of the projected top surface edges using one of a Canny edge detection technique and an intensity difference technique; and determining an amount of overlay of the projected top surface edges coincident with the top surface edges of the first image. The contour of the projected top surface edges is traversed according to Bresenham's method.

The step of determining an amount of overlay between the projected top surface edges and the top surface edges of the first image, comprises: performing a gradient descent search of the projected top surface edges using Powell's method. The matching score is generated by summing edge pixels of the overlaid projected top surface edges and the top surface edges of the first image.

The step of determining an amount of overlay between the projected top surface edges and the top surface edges of the first image, comprises: analyzing an intensity difference signature of the projected top surface edges; and adjusting an intensity threshold and resolution of the projected top surface edges. The method further comprises: acquiring a second image of the parcel; and updating the second image of the parcel with a signature of the first image. The method further comprises: tracking the parcel by assigning the projected top surface edges with a highest matching score as an updated parcel position and orientation.

In yet another exemplary embodiment of the present invention, a system for tracking a parcel on a planar surface comprises: a memory device for storing a program; a processor in communication with the memory device, the processor operative with the program to: acquire an image of the parcel located on the planar surface; determine edges of the parcel; project the edges onto the planar surface; determine which edges belong to each side of the parcel; calculate a cost function associated with the edges belonging to each side of the parcel; search the edges belonging to each side of the parcel to find edges having a lowest cost; and construct a matching configuration of the parcel using the edges having the lowest cost.

The image is acquired by a camera. The parcel is a polyhedral polygon. The planar surface is a conveyor belt. The edges are determined by using one of a Canny edge detection technique and a background image boundary. The edges are projected onto the planar surface from one of a top and bottom surface of the parcel. The cost function is a weighted sum of a plurality of factors, the factors including: a deviation from a perpendicularity between adjacent edges, a deviation from parcel dimensions for opposite edges, a deviation from the parcel dimensions for each edge, and a distance of the parcel from a predicted location. The matching configuration of the parcel includes an edge match for each side of the parcel.

In another exemplary embodiment of the present invention, a system for tracking a parcel on a planar surface comprises: a memory device for storing a program; a processor in communication with the memory device, the processor operative with the program to: acquire a first image of the parcel located on the planar surface; compute a three-dimensional (3D) position and orientation of the parcel according to its relative motion space; project top surface edges of the parcel associated with the computed 3D position and orientation onto the planar surface; determine an amount of overlay between the projected top surface edges and the top surface edges of the first image; and generate a matching score using the amount of overlay between the projected top surface edges and the top surface edges of the first image.

The first image is acquired by a camera. The parcel is a polyhedral polygon. The planar surface is a conveyor belt. The relative motion space of the parcel is defined by a vector (ΔX, ΔY, Δθ), which corresponds to position changes of the parcel in the X and Y directions and a rotational angle. The projection of the top surface edges onto the planar surface is computed using a Tsai model. The processor is further operative with the program code to acquire a second image of the parcel; and update the second image of the parcel with a signature of the first image. The processor is further operative with the program code to track the parcel by assigning the projected top surface edges with a highest matching score as an updated parcel position and orientation.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 is a top view and a side view of a parcel tracking system in accordance with an exemplary embodiment of the present invention;

FIG. 2 is a set of images captured by cameras of the parcel tracking system of FIG. 1;

FIG. 3 is a debug window of the of the parcel tracking system of FIG. 1;

FIG. 4 is a flowchart illustrating a method for tracking parcels on a planar surface according to an exemplary embodiment of the present invention;

FIG. 5 is a flowchart illustrating a method for tracking parcels on a planar surface according to another exemplary embodiment of the present invention;

FIG. 6 is a diagram illustrating a method for detecting an overlay between a hypothesized edge and a real edge according to yet another exemplary embodiment of the present invention;

FIG. 7 is a diagram illustrating a method for determining corresponding edges between a hypothesized edge and a real edge according to another exemplary embodiment of the present invention;

FIG. 8 is a diagram illustrating a method for determining corresponding edges between line segments of a hypothesized edge and a real edge according to yet another exemplary embodiment of the present invention; and

FIG. 9 is a diagram illustrating a method for inferring threshold, range and resolution data from an intensity difference signature according to another exemplary embodiment of the present invention.

### DETAILED DESCRIPTION OF EXEMPLARY EMBODIMENTS

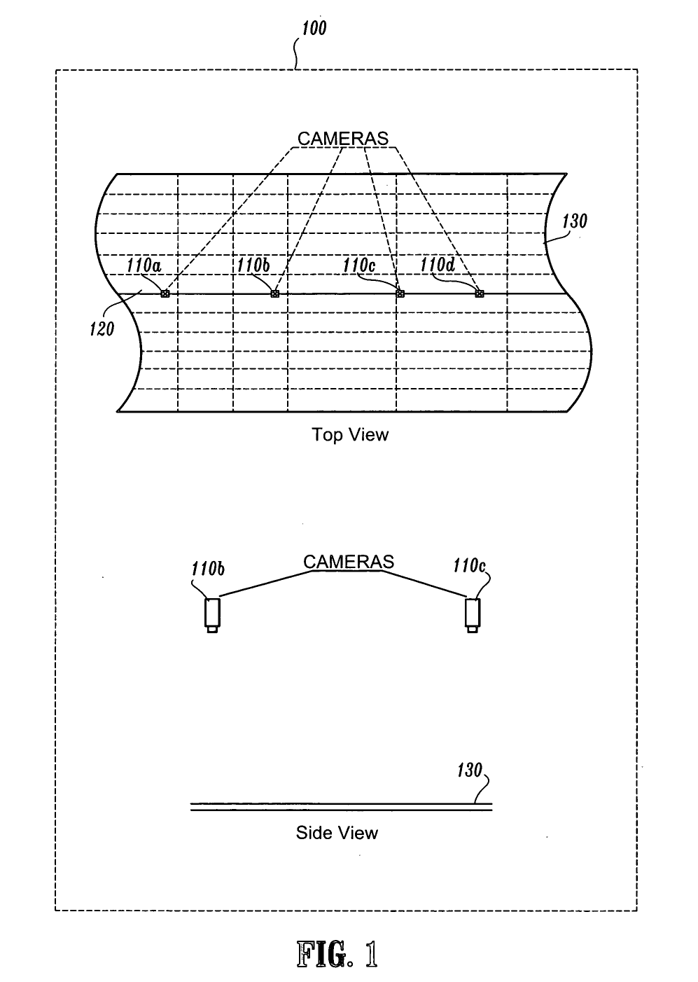

FIG. 1 is a top view and a side view of a parcel tracking system 100 in accordance with an exemplary embodiment of the present invention. As shown in FIG. 1, the parcel tracking system 100 may be incorporated as part of a complex logistical system having, for example, multiple induction conveyors feeding to a sortation or a singulation conveyor. The parcel tracking system 100 includes four cameras 100a-d placed on a center line 120 of a manipulation bed 130 in the direction of movement of parcels from a transition belt. Prior to receiving the parcels on the manipulation bed 130, the parcels are modeled and located while on the transition belt. Upon receiving the parcels from the transition belt, the manipulation bed 130, which includes a matrix of variable speed belts, manipulates the parcels before discharging them. The inflow speed and output speed of the parcels may be, for example, 0.5 m/s and 1.5 m/s, respectively.

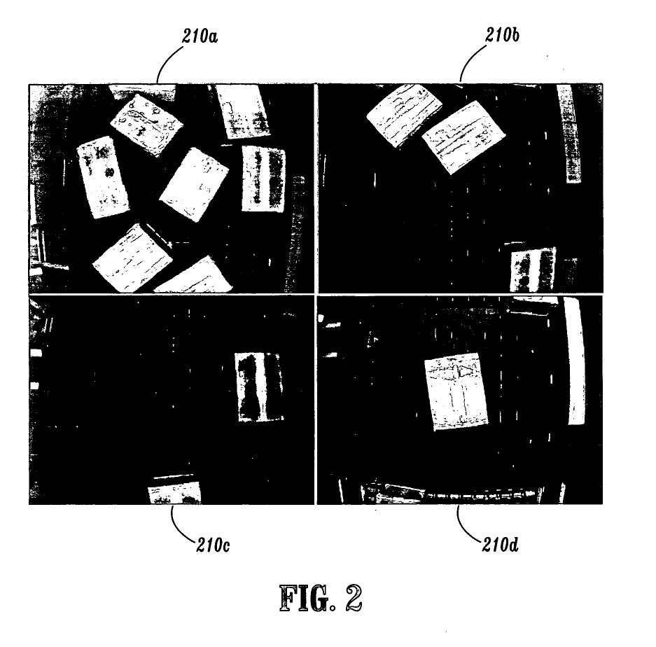

The cameras 110a-d are synchronized in sampling time and frequency and take pictures of the parcels, for example, every 33 ms. An exemplary set of images 210a-d captured by the cameras 110a-d is shown in FIG. 2. The combined internal and external calibration of the parcel tracking system 100 is capable of time-stamping sensor inputs as they arrive into a computer memory coupled to the system 100, thus enabling a metric registration of the cameras 110a-d with the manipulation bed 130. The cameras 110a-d are synchronized and calibrated in accordance with the computer vision and related algorithms disclosed in co-pending provisional patent applications entitled, “A Real-time Vision System for 3D Tracking of Free-Moving Particles” and “Fusion of Camera and Photo Sensors for Reconstructing the 3D Model of Parcels on a Conveyor Belt”, copies of which are herein incorporated by reference.

In particular, the cameras 110a-d are synchronized by time stamping-images as they are acquired and then storing data associated therewith in the computer memory of the tracking system 100. For example, the shutters of the cameras 110a-d may be synchronized by using a hardware triggering mechanism. The synchronization data may also be captured by a capture board of the tracking system 100. Once the data is captured, it is then time-stamped and transferred to the computer memory. As the shutter duration and time required to transfer images to the memory are both measurable, the time-stamping process is accurate to about 1 ms.

In addition to being synchronized, the cameras 100a-d are calibrated both internally and externally. Internal calibration is achieved by using measured three-dimensional (3D) grids associated with an image captured by each of the cameras 110a-d. The grids provide detectable sets of unique markers, and the four corners of these markers are measured in space by an off-line process using Tsai's calibration algorithm. After measuring the markers, internal parameters (e.g., radial distortion) of the cameras 110a-d are recovered.

External calibration of the position and orientation of the cameras 110a-d is achieved with respect to a common world coordinate system using a planar grid. Similar to the internal calibration technique, the grid provides automatically detected points that have known 3D locations in the common world coordinate system. Moreover, the placement of the planar grid or a marking board in predetermined locations enables a full series of locations to be configured that cover all of the area observed by the cameras 110a-d.

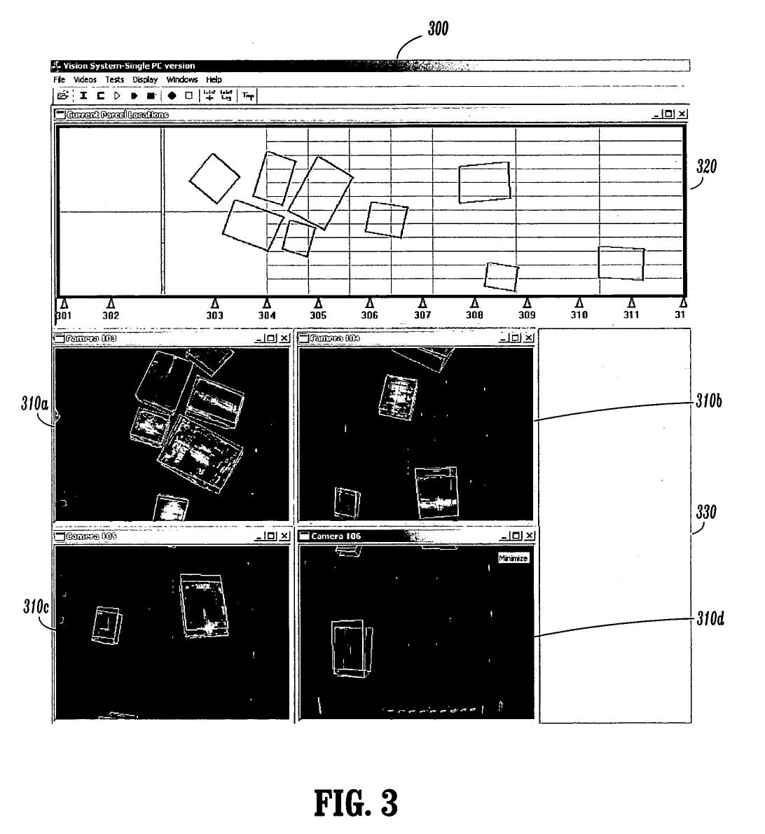

As shown in FIG. 1, upon receipt of the parcels from the transition belt, the parcels become disposed on the manipulation bed 130. At this time, the parcels may be located and tracked, and they may continue to be tracked as they are moved to a conveyor belt coupled to one end of the manipulation bed 130 by another set of cameras. The tracked parcels may be displayed in real-time on a debug window 300 of the tracking system 100 as shown in FIG. 3. As shown in FIG. 3, the debug window 300 may be configured to display the parcels as they are tracked by each of the cameras 110a-d in corresponding individual windows 310a-d. The debug window 300 may also display all of the tracked parcels in a single window 320. The debug window 300 may further include an additional window 330 that displays, for example, a zoomed in view of a parcel, parcel data or commands for controlling the tracking system 100.

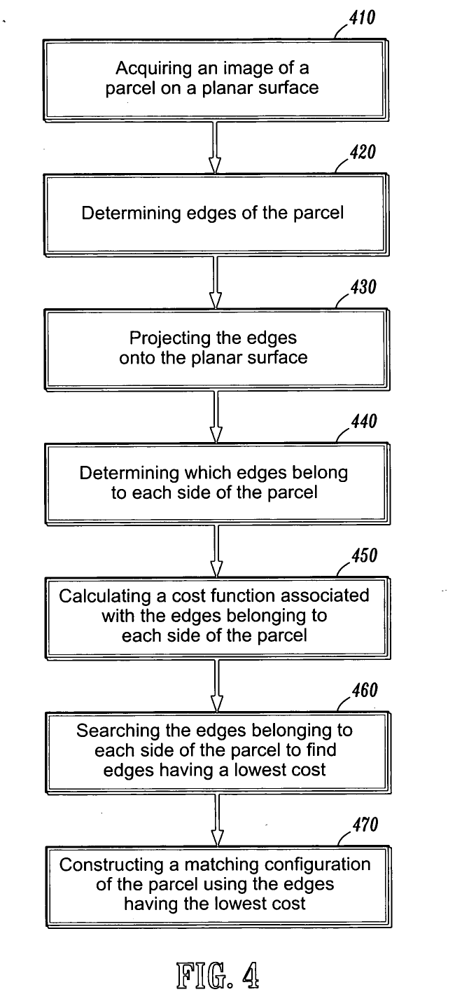

FIG. 4 is a flowchart illustrating a method for tracking parcels on a planar surface. As shown in FIG. 4, a series of images of a parcel or parcels, which are traveling along a planar surface such as a conveyor belt, a singulator belt or the manipulation bed 130, are acquired by the cameras 110a-d (410). After acquiring the images of the parcels, edges are determined for each side of the parcels in each image (420). The edges are determined using a Canny edge detection technique. The edges may also be determined by using boundary points from a background subtracted image as the edges.

In both the Canny edge detection and background image boundary point selection techniques, the edges are determined after fitting straight lines to edge pixels of the images. This is done by first obtaining a set of connected edges for an image. A one-dimensional (1D) Hough accumulator then segments the orientation of the connected edges by using, for example, a fixed length of a line segment that is eight pixels long, and moving the line segment over segments of the connected edges one pixel at a time. At each pixel, the fixed length line segment is fit to the rest of the connected edge starting from the pixel. Accumulation of the directions of the fixed length line segments in the 1D Hough accumulator enables the recovery of the orientation of the longest line that can be fit to the connected edges. The directions are then recorded and a longest straight-line segment that can be fit to the connected set of edges can be found. Once the direction of the longest straight line is found, the actual line segment parameters can be recovered using a refinement fitting process. If necessary, a second fitting process can be performed to fully recover the edge segment.

Although these techniques typically work best with long connected edges such as those found on the boundary of the top face or surface of a parcel, when parcels with short edges are analyzed, at least half the length of the short edges can be found. This is possible by observing the intensity changes along the sides of the parcels. For example, a tape in the middle of the parcel can yield two connected edges on the same side of the parcel. In addition, when dealing with short edged parcels, further morphological operations may be performed after either the Canny edge detection or background subtracted image boundary point techniques to enhance the connectivity of the edge segments. Morphological operations such as open, close, dilation or erosion may be used to enhance the connectivity of the edge segments. A combination of dilation and erosion operations can be used to close the gaps in edge maps yielding long connected edges, thus yielding better edge fitting results.

Once the edges of the parcels have been determined, the edges are projected onto the two-dimensional (2D) surface of the manipulation bed 130 (430). The edges can be projected from the top or bottom surface of each parcel in each image acquired by the cameras 110a-d. A reference coordinate frame for the edges is then transferred to the coordinates of the manipulation bed 130 thereby enabling the cameras 110a-d to become integrated. After the edges are projected onto the 2D surface of the manipulation bed 130, the parcel must then be fit onto the projected edges. Prior to fitting the parcel onto the projected edges, all candidate edges of the projected edges that belong to a particular side of the parcel are determined (440). This is accomplished, for example, by screening the candidate edges using a number of variables, such as the distance from each projected location to the edges, the lengths of the edges, and the angular orientation of the edges.

After determining the candidate edges, a cost function associated with the edges belonging to each side of the parcel is calculated (450). The cost function is, for example, a weighted sum of several factors. These factors may be, for example: a deviation from the perpendicularity between adjacent edges, a deviation from parcel dimensions for opposite edges, a deviation from the parcel dimensions for each edge, and a distance of the parcel from a projected or hypothesized location. Given the cost function, a combination of the factors that has a lowest cost is then determined (460).

This is done by searching the total number of combinations or hypotheses for each side of the parcel and then determining which of the edges belonging to each side of the parcel has the lowest cost. If the number of hypotheses is prohibitively large, a hierarchical approach can be used where a set of opposite edges is first determined for both perpendicular directions. After the edges having the lowest cost are determined, an optimal or matching configuration of the parcel or parcels is constructed by piecing together the lowest cost edges (470), thus enabling the location of the parcel or parcels to be known in real-time and therefore tracked.

In this method, if less than four edges of the parcel or parcels are available, priority is given to parcels that have four edges. In doing so, the cost function of a parcel having less than four edges is calculated, and using the available edges, the optimal configuration of the parcel is constructed by piecing together the lowest cost edges. In addition, when parcels are located near each other on the manipulation bed 130, there is the possibility of overlapping edges. In this case, both parcels are evaluated and the lowest cost edges are assigned to their associated parcel. The non lowest cost edges associated with that parcel are then removed and the remaining edges are used for the evaluation of an adjacent parcel.

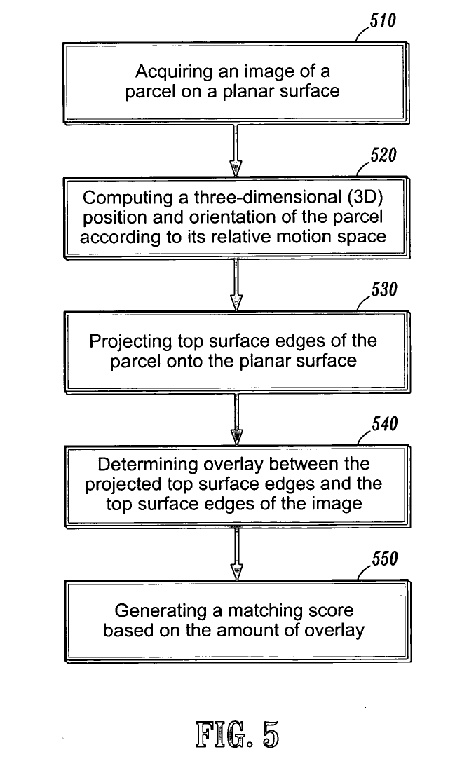

FIG. 5 is a flowchart illustrating a method for tracking parcels on a planar surface according to another exemplary embodiment of the present invention. As shown in FIG. 5, an image or a series of images of a parcel or parcels is acquired by one or all of the cameras 110a-d (510). After acquiring the image, a 3D position and orientation of the parcel is computed according to its relative motion space on the planar surface (520). In this step, the relative motion space (e.g., ΔX, ΔY, Δθ), which is discretized into finite grids on the planar surface, is used to compute the 3D position of the parcel.

The geometry and current configuration (e.g., orientation and position) of the computed 3D position of the parcel is described by its coordinates and vertices (xₚᵢ, yₚᵢ), where p and i are indices for the parcels and vertices, respectively. The center of the computed 3D position of the parcel (cxₚᵢ, cyₚᵢ) is defined as the arithmetic mean of the vertices and an updated position of the parcel may be updated according to the following equations:
x←(x−cx) cos Δθ−(y−cy) sin Δθ+Δx+cx [1]
y←(x−cx) sin Δθ−(y−cy) cos Δθ+Δy+cy [2]

Upon computing the 3D position of the parcel, the top surface edges of the parcel are projected in all visible views of the planar surface available in a world coordinate system (530). In particular, the top surface edges of the parcel are projected according to the positions of the vertices in the world coordinate system and the geometry of one or all of the cameras 110a-d. The geometry of the cameras 110a-d is estimated by calibrating the cameras 110a-d using the calibration technique described above with reference to FIG. 2. Once the geometry of the cameras 110a-d is known, the projection of a 3D point from the top surface edges is computed using a Tsai model. As there may be some radial distortion involved when projecting the top surface edges, long edges can be divided into several segments and the parcel can be considered as being composed of many short edges, thus alleviating the effects of radial distortion.

Subsequent to projecting the top surface edges of the parcel onto the planar surface, an amount of overlay between the projected top surface edges and the observed image edges is measured (540). In order to measure the amount of overlay quickly and in real-time, several operations may take place, for example: rapid traversal of the projected and/or hypothesized top surface edges, rapid detection of edge pixels of the hypothesized top surface edges, and rapid determination of edge overlay. These operations are performed numerous times in order to accommodate the large amount of grids (e.g., 270) and parcels on the manipulation bed 130. In order to achieve real-time feedback, these operations are performed on each parcel in less than 33 ms.

In the rapid traversal operation, a contour traversal of the parcel is performed using Bresenham's method. This operation occurs very quickly because the parcels are assumed to be polyhedral polygons and thus their projected top surface edges are straight lines. As a result, the position of each projected edge pixel can be computed in just two or three integer additions.

In the rapid edge detection operation, an edge detection method such as Canny edge detection is used. When coupling Canny edge detection with, for example, the Intel standard image processing library (IPL), projected top surface edges may be detected in a 640×480 image in about 10 ms. When performing rapid edge detection, an intensity difference edge detection technique can also be used. For example, the intensity difference between pixels on two sides of the projected top surface edges can be computed and the absolute intensity difference of the computed intensity differences can be determined and used as a threshold for detecting edge pixels of the projected top surface edges. This technique has been shown to be faster than Canny edge detection in some situations. In addition, this technique only requires detection of edge pixels along the projected top surface edges.

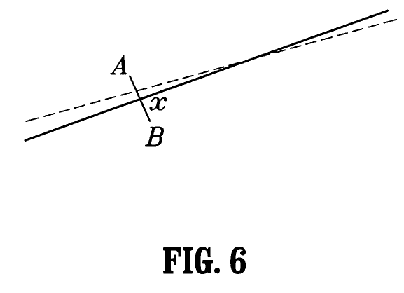

In the rapid determination of overlay technique, it is determined if a projected top surface edge pixel is coincident with a top surface edge pixel of the image. This is done by checking to see if there is an edge pixel in an interval x between a pair of points A and B as shown, for example, in FIG. 6. In FIG. 6, the projected top surface edge is indicated by a solid line and the top surface edge of the image is indicated by a dashed line. Using the data acquired from the edge detectors, overlay is then detected by checking to see if there is an edge pixel in the AB interval, and by checking to see if the absolute intensity difference between the points A and B is greater than a predetermined threshold.

When an edge pixel of the projected top surface is overlaid with a top surface edge pixel, the edge pixel of the projected top surface is identified as a hit or a match. The number of hits associated with each pixel of the overlaid projected top surface edges and the top surface edges is then summed and used to generate an overall hit rate or a matching score (550). The matching score is then used by the tracking system 100 to track the parcel by using the projected top surface edges having a highest matching score as the current or updated position and orientation of the parcel on the manipulation bed 130.

Although the tracking techniques described above with reference to FIGS. 4 and 5 are highly capable of finding a global optima of the projected top surface edges when a high resolution image is available, a high resolution image is not always available. Therefore, when a lower resolution image is used, the tracked parcels may become subject to a jittering effect. In order to more accurately determine the amount of overlay between the projected top surface edges and the top surface edges of the image, a gradient descent search of the projected top surface edges may be performed. In particular, a gradient descent search using Powell's method, which is a generic optimization algorithm, may be performed to evaluate an obtained matching score or to determine the cost function.

In yet another exemplary embodiment of the present invention, corresponding edge pixels between the projected top surface edges and the top surface edges of the image can be determined using correspondence based registration methods such as an iterative closest points (ICP) method or a Hough transform voting method. In the ICP method, an iteration between the steps of determining corresponding edge pixels and minimizing the distance between corresponding edge pixels takes place, and in the Hough transform voting method tracking is further optimized using corresponding line segments.

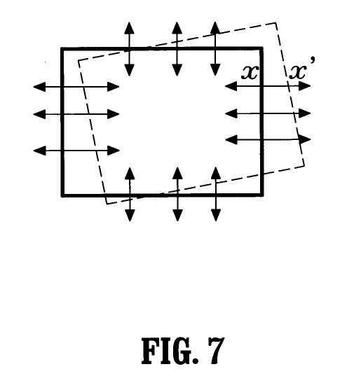

An example of using the ICP method to find corresponding edge pixels is shown in FIG. 7. As shown in FIG. 7, a plurality of rays are projected (e.g., indicated by arrows) from perpendicular edges of the projected top surface edges (e.g., indicated by a dashed box) to the top surface edges of the image (e.g., indicated by a solid box). The nearest edge pixel x′ of a the top surface edge pixel x of the image is determined to be the edge pixel corresponding to where the ray originated. Once the corresponding edge pixel is determined, the transform (e.g., Δx, Δy, Δθ), which minimizes the sum of a squared distance between corresponding edge pixels, is found. Using the same technique, a 2D set of data can be analyzed by iterating the above steps until the distance between corresponding edge pixels is reduced. In addition, this technique can be used in conjunction with Canny edge detection or with an edge detection method that is used to detect edges along the one-dimensional (1D) rays to reduce computation time.

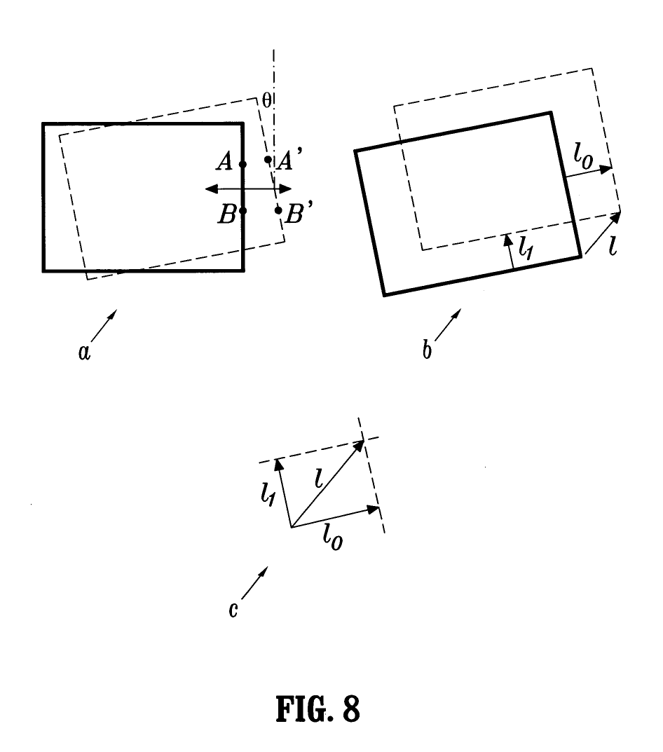

In the Hough-transform method, which is particularly robust when dealing with outliers, tracking is established based on corresponding line segments. Before applying the method, corresponding edge pixels between projected top surface edges and top surface edges of the image are found. Next, a line segment, such as a small line segment surrounding an edge pixel of one of the projected top surface edges is located. An example of a line segment (e.g., A ‘B’) that has been located is shown in image (a) of FIG. 8. By using the line segment A ‘B’, a correspondence between the line segment A ‘B’ and an original top surface edge line segment (e.g., AB) can be found, thus providing an estimate of a rotation angle (e.g., θ) of the two surface edges. This process can be repeated numerous times for many line segments along the boundaries of the projected top surface edges and a histogram or density estimate of the rotation angle can be constructed and a resulting highest mode of the histogram or density estimate will correspond to the rotation angle estimate.

After the rotation angle has been estimated, the projected top surface edges are rotated so that they and the top surface edges of the image differ by only a translation (e.g., l). The corresponding edge pixels of the projected top surface edges and top surface edges of the image are again found, and the vectors (e.g., l₀ and l₁ shown in image (b) of FIG. 8) pointing from the corresponding edge pixel of the projected top surface to its associated edge pixel of the top surface of the image are thus a projection of the translation l in normal directions (e.g., the directions along edges l₀ and l₁). In other words, a line n₀ that is perpendicular to l₀ and that passes through the end point of l₀, passes through the endpoint of l as well. An example of this is illustrated by image (c) of FIG. 8. Similarly, n₁ may pass though the endpoint of l. Because this technique decouples the estimation of the rotation angle and the translation vector, distracting parallel edges such as those introduced by parallel edges in, for example, an extrusion model do not affect the estimation of the rotation angle.

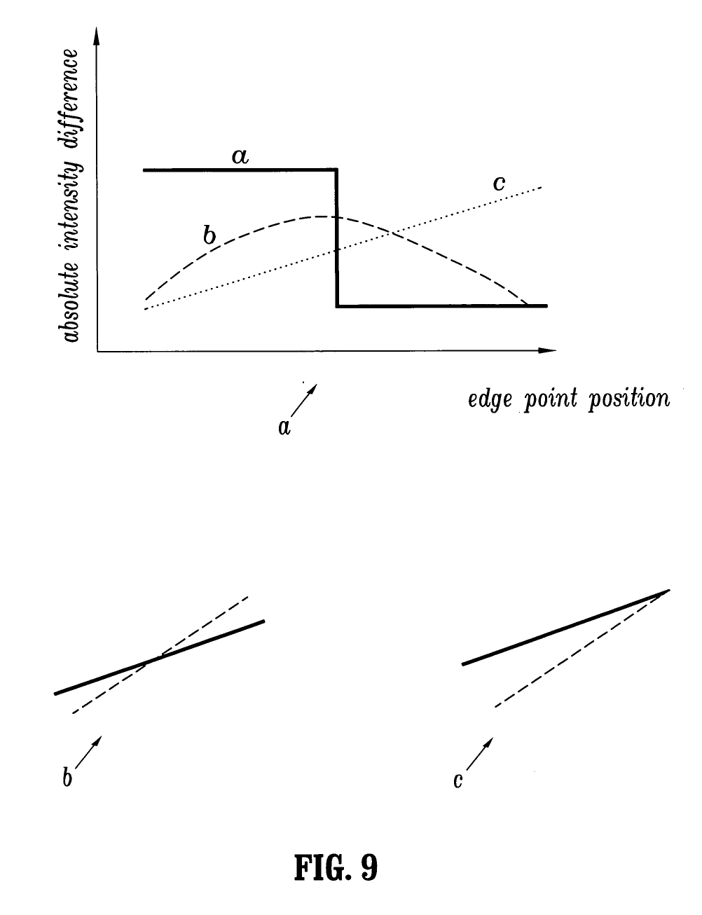

In another exemplary embodiment of the present invention, intensity differences of the images of the parcels may be utilized to determine underlying structures. The intensity differences may be used because the intensity gradually changes within a foreground and background and suddenly changes between the foreground and background of an image. Thus, an intensity difference signature of the projected top surface edges can be analyzed to diagnose errors in the projected top surface edges. An example of an error that can be corrected by analyzing intensity differences is shown in FIG. 9.

For example, in an intensity difference graph in image (a) of FIG. 9, a curve a, which implies occlusion on the right half of an edge, would preclude the edge pixels on the right half of the curve a from being detected. In another example, curve b, which corresponds to image (b), indicates that a center part of the projected top surface edge and the top surface edge of the image coincide, yet their ends differ. Similarly, curve c, which corresponds to image (c), indicates that an end part of the projected top surface edge and the top surface edge of the image coincide, yet their ends differ. In both cases, the translation and rotation angle are off. However, by adaptively adjusting the intensity threshold and discretization resolution parameters, the errors can be corrected.

In yet another exemplary embodiment of the present invention, successive images of the parcels can be updated with prior image signatures. This occurs because the images of the parcels are captured at a high frame rate and thus the changes in the position and orientation of the parcels between frames is small. Therefore, signatures of a previous frame such as threshold, un-occluded region range, and motion parameter resolution, can be inherited by a subsequent frame and updated in the current frame.

It is to be further understood that because some of the constituent system components and method steps depicted in the accompanying figures may be implemented in software, the actual connections between the system components (or the process steps) may differ depending on the manner in which the present invention is programmed. Given the teachings of the present invention provided herein, one of ordinary skill in the art will be able to contemplate these and similar implementations or configurations of the present invention.

It should also be understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention.

It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

1. A method for tracking a parcel on a planar surface, comprising:
acquiring an image of the parcel located on the planar surface;
determining edges of the parcel;
projecting the edges onto the planar surface;
determining which edges belong to each side of the parcel;
calculating a cost function associated with the edges belonging to each side of the parcel;
searching the edges belonging to each side of the parcel to find edges having a lowest cost; and
constructing a matching configuration of the parcel using the edges having the lowest cost.

2. The method of claim 1, wherein the edges are determined by using one of a Canny edge detection technique and a background image boundary.

3. The method of claim 2, wherein the edges are determined after fitting straight edges to edge pixels of the image, wherein the step of fitting straight edges comprises:
obtaining a set of connected edges from the image;
fitting lines to edge pixels of the image;
recording directions of the lines in an accumulator;
determining straight lines that can be fit to the set of connected edges; and
fitting the straight lines to the edge pixels of the image.

4. The method of claim 3, wherein the accumulator is a Hough accumulator.

5. The method of claim 1, wherein the edges are projected onto the planar surface from one of a top and bottom surface of the parcel.

6. The method of claim 1, wherein the step of determining which edges belong to each side of the parcel comprises:
screening the projected edges with a set of parameters for determining which of the projected edges belong to each side of the parcel, wherein the set of parameters includes a distance of each edge from its projected location, a length of each edge, and an angular orientation of each edge.

7. The method of claim 1, wherein the step of determining which edges belong to each side of the parcel comprises:
determining corresponding edge pixels between the projected top surface edges and the top surface edges of the image using a correspondence based registration method.

8. The method of claim 7, wherein the correspondence based registration method is one of an iterative closest points (ICP) method and a Hough transform voting method.

9. The method of claim 1, wherein the step of determining which edges belong to each side of the parcel comprises:
analyzing an intensity difference signature of the projected top surface edges; and
adjusting an intensity threshold and resolution of the projected top surface edges.

10. The method of claim 1, wherein the cost function is a weighted sum of a plurality of factors, the factors including: a deviation from a perpendicularity between adjacent edges, a deviation from parcel dimensions for opposite edges, a deviation from the parcel dimensions for each edge, and a distance of the parcel from a predicted location.

11. The method of claim 10, wherein the lowest cost function is determined by finding a combination of the plurality of factors that has a lowest cost.

12. The method of claim 1, wherein the matching configuration of the parcel includes an edge match for each side of the parcel.

13. A method for tracking a parcel on a planar surface, comprising:
acquiring a first image of the parcel located on the planar surface;
computing a three-dimensional (3D) position and orientation of the parcel according to its relative motion space;
projecting top surface edges of the parcel associated with the computed 3D position and orientation onto the planar surface;
determining an amount of overlay between the projected top surface edges and the top surface edges of the first image; and
generating a matching score using the amount of overlay between the projected top surface edges and the top surface edges of the first image.

14. The method of claim 13, wherein the relative motion space of the parcel is defined by a vector (ΔX, ΔY, Δθ), which corresponds to position changes of the parcel in the X and Y directions and a rotational angle.

15. The method of claim 13, wherein the projection of the top surface edges onto the planar surface is computed using a Tsai model.

16. The method of claim 13, wherein the step of determining an amount of overlay between the projected top surface edges and the top surface edges of the first image, comprises:
traversing a contour of the projected top surface edges to determine a position of edge pixels on the projected top surface edges;
detecting the edge pixels of the projected top surface edges using one of a Canny edge detection technique and an intensity difference technique; and
determining an amount of overlay of the projected top surface edges coincident with the top surface edges of the first image.

17. The method of claim 16, wherein the contour of the projected top surface edges is traversed according to Bresenham's method.

18. The method of claim 13, wherein the step of determining an amount of overlay between the projected top surface edges and the top surface edges of the first image, comprises:
performing a gradient descent search of the projected top surface edges using Powell's method.

19. The method of claim 18, wherein the matching score is generated by summing edge pixels of the overlaid projected top surface edges and the top surface edges of the first image.

20. The method of claim 13, wherein the step of determining an amount of overlay between the projected top surface edges and the top surface edges of the first image, comprises:
analyzing an intensity difference signature of the projected top surface edges; and
adjusting an intensity threshold and resolution of the projected top surface edges.

21. The method of claim 13, further comprising:
acquiring a second image of the parcel; and
updating the second image of the parcel with a signature of the first image.

22. The method of claim 13, further comprising:
tracking the parcel by assigning the projected top surface edges with a highest matching score as an updated parcel position and orientation.

23. A system for tracking a parcel on a planar surface, comprising:
a memory device for storing a program;
a processor in communication with the memory device, the processor operative with the program to:
acquire an image of the parcel located on the planar surface;
determine edges of the parcel;
project the edges onto the planar surface;
determine which edges belong to each side of the parcel;
calculate a cost function associated with the edges belonging to each side of the parcel;
search the edges belonging to each side of the parcel to find edges having a lowest cost; and
construct a matching configuration of the parcel using the edges having the lowest cost.

24. The system of claim 23, wherein the image is acquired by a camera.

25. The system of claim 23, wherein the parcel is a polyhedral polygon.

26. The system of claim 23, wherein the planar surface is a conveyor belt.

27. The system of claim 23, wherein the edges are determined by using one of a Canny edge detection technique and a background image boundary.

28. The system of claim 23, wherein the edges are projected onto the planar surface from one of a top and bottom surface of the parcel.

29. The system of claim 23, wherein the cost function is a weighted sum of a plurality of factors, the factors including: a deviation from a perpendicularity between adjacent edges, a deviation from parcel dimensions for opposite edges, a deviation from the parcel dimensions for each edge, and a distance of the parcel from a predicted location.

30. The system of claim 23, wherein the matching configuration of the parcel includes an edge match for each side of the parcel.

31. A system for tracking a parcel on a planar surface, comprising:
a memory device for storing a program;
a processor in communication with the memory device, the processor operative with the program to:
acquire a first image of the parcel located on the planar surface;
compute a three-dimensional (3D) position and orientation of the parcel according to its relative motion space;
project top surface edges of the parcel associated with the computed 3D position and orientation onto the planar surface;
determine an amount of overlay between the projected top surface edges and the top surface edges of the first image; and
generate a matching score using the amount of overlay between the projected top surface edges and the top surface edges of the first image.

32. The system of claim 31, wherein the first image is acquired by a camera.

33. The system of claim 31, wherein the parcel is a polyhedral polygon.

34. The system of claim 31, wherein the planar surface is a conveyor belt.

35. The system of claim 31, wherein the relative motion space of the parcel is defined by a vector (ΔX, ΔY, Δθ), which corresponds to position changes of the parcel in the X and Y directions and a rotational angle.

36. The system of claim 31, wherein the projection of the top surface edges onto the planar surface is computed using a Tsai model.

37. The system of claim 31, wherein the processor is further operative with the program code to:
acquire a second image of the parcel; and
update the second image of the parcel with a signature of the first image.

38. The system of claim 31, wherein the processor is further operative with the program code to:
track the parcel by assigning the projected top surface edges with a highest matching score as an updated parcel position and orientation.
